(19) United States
(12) Patent Application Publication
(10) Pub. No.: US 2014/0367956 A1
(43) Pub. Date: Dec. 18, 2014

(54) Methods And Systems For Organizing, Handling, And Installing Shelf Labels, Signs And Strips In A Retail Environment

(71) Applicant: Vestcom New Century LLC, New Century, KS (US)

(72) Inventors: Michael Wilkinson, Overland Park, KS (US); Jeffrey Blackwell, Maumelle, AR (US); Scott Aten, Little Rock, AR (US); David Adler, Interlaken, NJ (US); Jeffrey Weidauer, Little Rock, AR (US)

(21) Appl. No.: 14/305,517

(22) Filed: Jun. 16, 2014

Related U.S. Application Data
(60) Provisional application No. 61/835,219, filed on Jun. 14, 2013.

(51) Int. Cl. B42D 15/04; B42C 9/00

(52) U.S. Cl. CPC B42D 15/045; B42C 9/0006
USPC 281/21.1; 412/8

(57) ABSTRACT

Various methods and systems for manufacturing and using shelf labels, signs, and strips in a retail establishment are disclosed that employ self-adherent stacks of shelf display materials. Some display materials include an ordered set of a plurality of individual display materials. Each of the individual display materials is releasably adhered to an adjacent individual display material in the ordered set, whereby forming a pad. The ordered set is arranged in a predetermined sequence of installation for each of the individual display materials in a retail environment. In another embodiment, a pad of shelf labels includes a plurality of sheets and releasable adhesive. Each sheet includes a single shelf label having a unique combination of product-identifying indicia and price information, and the releasable adhesive adheres each sheet to an adjacent sheet in a stacked configuration. The sheets are ordered in a predetermined sequence of installation in a retail environment.

### CROSS-REFERENCE TO RELATED APPLICATIONS

This application claims the benefit of U.S. Patent Application Ser. No. 61/835,219 filed Jun. 14, 2013, the disclosure of which is incorporated herein by reference in its entirety.

### BACKGROUND

Shelf display materials such as printed shelf labels, strips, and signage are currently printed remotely and delivered to an individual store or distribution center, or printed in the back room of a given store. These printed messages are often sorted using various item location data sources including category, planogram order, or store walk sequence. This sorting process increases efficiency and provides labor savings by reducing the time required to (i) sort the labels prior to installation, and (ii) place each individual tag on the shelf edge in front of the appropriate item located in the store aisles. The shelf display materials are typically printed and delivered on sheets containing multiple labels on a single sheet, thus requiring pre-hang breakdown by store employees. Some systems eliminate the need for manual breakdown of labels by distributing the shelf display materials as boxes or other packages of loose display materials. These boxes of loose display materials are susceptible to mishandling or dropping, in a manner that shuffles the loose display materials, thus disorganizing the display materials and negating the labor savings achieved by eliminating the need for breakdown through the increased labor of sorting the disorganized display materials. More efficient methods for organizing and installing shelf display materials are needed.

### SUMMARY

In various embodiments, methods and systems for printing, organizing, handling, and installing shelf labels, signs, and strips in a retail establishment are disclosed that employ pre-adhered and self-adherent stacks of shelf display materials.

In one embodiment, display materials for a retail environment include an ordered set of a plurality of individual display materials. Each of the individual display materials is releasably adhered to an adjacent individual display material in the ordered set, whereby forming a pad. The ordered set is arranged in a predetermined sequence of installation for each of the individual display materials in the retail environment.

In another embodiment, a pad of shelf labels for a retail environment includes a plurality of sheets and releasable adhesive. Each sheet includes a single shelf label having a unique combination of product-identifying indicia and price information, and the releasable adhesive adheres each sheet to an adjacent sheet in a stacked configuration. The sheets are ordered in a predetermined sequence of installation in the retail environment.

In still another embodiment, a method of manufacturing display materials for a retail environment includes steps: (a) accessing a content database containing display information for individual display materials; (b) accessing a store detail database containing sequence information for the retail environment; (c) combining the display information with the sequence information to prepare an ordered set of individual display materials; (d) printing each of the individual display materials; and (e) applying reusable adhesive to adhere the individual display materials to each other in accordance with the sequence information to form a pad of ordered display materials. The reusable adhesive allows the individual display materials to be coupled to store shelves after being separated from the pad.

### BRIEF DESCRIPTION OF THE DRAWINGS

FIG. 1 depicts an embodiment of the system of the present invention for preparing shelf display materials.

FIG. 2 depicts an embodiment of the system of the present invention for preparing shelf display materials.

FIG. 3 depicts an embodiment of the method of the present invention for preparing shelf display materials.

### DETAILED DESCRIPTION

The invention disclosed herein provides for a self-adherent pad formed from shelf display materials adhered to each other in a specific order to reduce the time and expense of placing the shelf display materials in use in a retail environment. In retail environments, a single store may simultaneously display thousands of products for sale. Periodically, product and price information may require updates to shelf display materials adjacent to each specific product. Similarly, advertising or signage materials located throughout the retail environment may require periodic updates with new materials. The placement of the shelf display materials is a time-consuming and error prone process. Providing an organized and easy method of distributing and placing the shelf display materials can greatly reduce the time required to place the materials and the rate of errors in placement of the materials.

In various embodiments, the disclosed invention includes a method to organize individual price labels or other shelf display materials in a sequence that matches the physical arrangement of goods within a retail environment. In some embodiments, the shelf display materials are organized with a single label on each sheet so that no additional breakdown by store employees is necessary. In some embodiments, the shelf display materials are adhered to each other in the desired sequence.

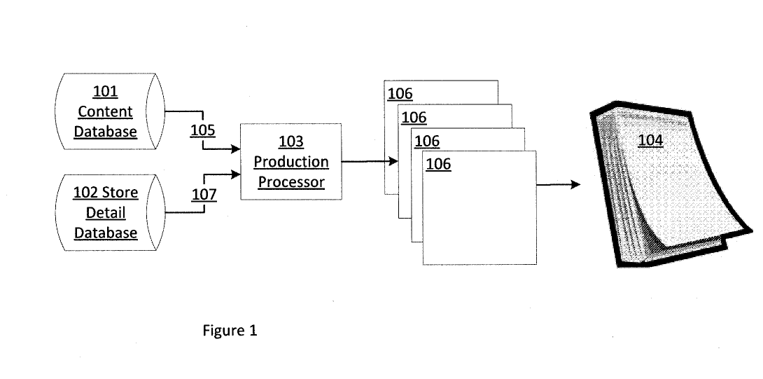

Referring now to FIG. 1, an embodiment of the system of the present invention for preparing shelf display materials is depicted. A content database 101 contains the content for the shelf display materials such as product descriptions, prices, logos, images, and other items that may be included on shelf display materials in a retail environment. The database 101 may also contain information regarding the layout and size of each tag, strip, sign, or other shelf display or other materials. The content manager database 101 may be updated as such information is revised or new information is added to the database 101.

The store detail database 102 contains the proper sequence of the shelf display or other materials in a store. In some embodiments, this sequence information includes, but is not limited to, the arrangement of products in the store so that adjacent shelf display materials will be printed and ordered adjacent to each other in the labels sent to each store. In other embodiments, the store detail database 102 may contain sequencing information based on category, planogram or walk sequence for each aisle in an individual store, depending on the retailer's installation procedure for shelf display materials. The store detail database 102 may contain details regarding the sequencing on more than one store layout, or on a single layout. The store detail database 102 may be updated as the store layout is revised or new elements are added or removed from a store layout.

The content database 101 and the store detail database 102 comprise logical databases and may be stored as tables in the same database or in different databases. In some embodiments, the database 101 and 102 may comprise flat files or media files stored in a manner accessible to the production processor 103. No specific technology or format for storing data is limiting of databases 101 and 102.

When it is desired to generate shelf display or other materials for a store, a user initiates the process of generating the materials. Production processor 103 retrieves content data 105 from content database 101 and sequencing information 107 from store detail database 102. In some embodiments, production processor 103 comprises a software program executing on a computer. In other embodiments, production processor 103 may be a task specific device or integrated into a printing device. Production processor 103 combines the two data sources 101 and 103 to generate an ordered printing list for the shelf display materials 106. Based on the combined data sources, the shelf display materials 106 may be printed in the exact order in which they installed in the aisles of each individual store to create an ordered set of individual display materials. The display materials 106 may also be sorted by size or other attributes for consistency and ease of handling during the installation process. In a preferred embodiment, once the shelf display materials are printed, they are grouped in one or more stacks of sheets 106 each containing a single display material, rather than sheets containing a plurality of shelf display materials.

In some embodiments, adhesive is added to bind each stack of shelf display materials 106 into a pad 104 of attached materials. Binding the stack of shelf display materials 106 into a pad 104 of attached materials accomplishes two distinct needs. First, the adhesive attaches the sheets 106 in the appropriate order in pad 104. Second, in some embodiments the adhesive may be used to attach each sheet 106 to the appropriate shelf edge or other display location. In those embodiments, the shelf display materials 106 are adhered to each other in the desired order using a reusable adhesive so that the materials form a pad 104. The top label in the pad 104 may be removed from the pad and attached to a shelf or other retail display equipment using the same adhesive that previously held the sheet 106 on pad 104.

In some embodiments, production processor 103 not only executes the sorting and printing procedure, but also adds the adhesive to each piece of shelf display material in the appropriate location on the material based on size and adhesive design requirements and stacks the materials to form pad 104. In other embodiments, production processor 103 may comprise a printing device capable of printing and adhering the labels in pad 104, or it may comprise a computer or other device running software capable of sending appropriate print jobs to an actual printer such as via a locally attached printing device, a local network printer, or to a remote or commercial printer via a wide area network. In some embodiments, the production processor 103 may generate a print file that can be later delivered to a printer for actual printing and preparation of the adhered stack 104 of shelf display materials.

The resulting pad 104 of shelf display materials contains materials 106 that are sorted in the desired order so that a store employee may start at the top of stack 104 and walk through a store installing shelf display materials in order as they progress through the store without inefficient retracing of steps. In a preferred embodiment, each page 106 in the stack contains a single piece of shelf display or other material that may be removed the stack and attached to a shelf or other display location without further modification.

The processor 103 may divide a stack for a store into one or more separate stacks or subsets of sheets 106 to prevent a single stack from having too many sheets 106, to logically divide the sheets 106 for installation in various parts of the store, or other similar factors. These factors may be considered during the print/adhere process and may result in several adhered tag stacks for a single store section. Each stack may then be adhered into a separate pad 104.

The top or bottom sheet, or both, of each pad 104 may include additional information to assist in use of the shelf display materials, such as an identifier for the pad, the starting point of the pad 104 within the physical layout of the store, or the identifier for the next pad 104 to select when the current pad 104 has been completely installed in the store. The installer uses the identification tag to find the appropriate starting point in the store. The amount and location of the adherent material is predetermined based on size and installation requirement factors. The top identification tag sheet 106 may alert the installer that this stack is the next in the installation sequence. The bottom sheet 106 in the pad 104 may provide the identifier for the next pad to use during installation.

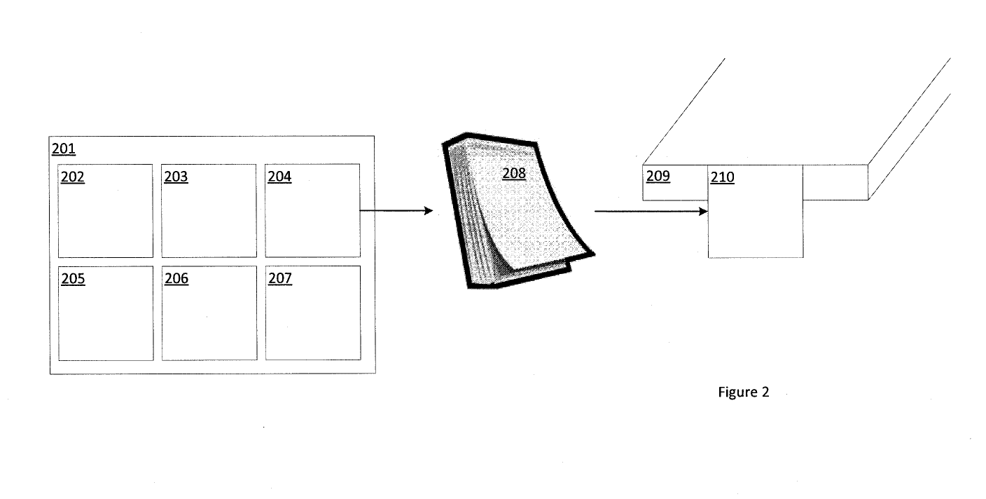

Referring now to FIG. 2, a schematic view of an embodiment of the system of providing the shelf display materials for a store is depicted. The pads 202, 203, 204, 205, 206 and 207 are loaded into a box or other shipping container 201. The pads are packed in walk sequence or other desired order to eliminate additional sorting when opened in each individual store. Installation is completed by removing an appropriate pad 208 (e.g., respective pads 202, 203, 204, 205, 206, 207) using the top location identification tag and attaching each tag 210 in the pad 208 using the adherent material at the proper shelf edge location on shelf 209 or other display location.

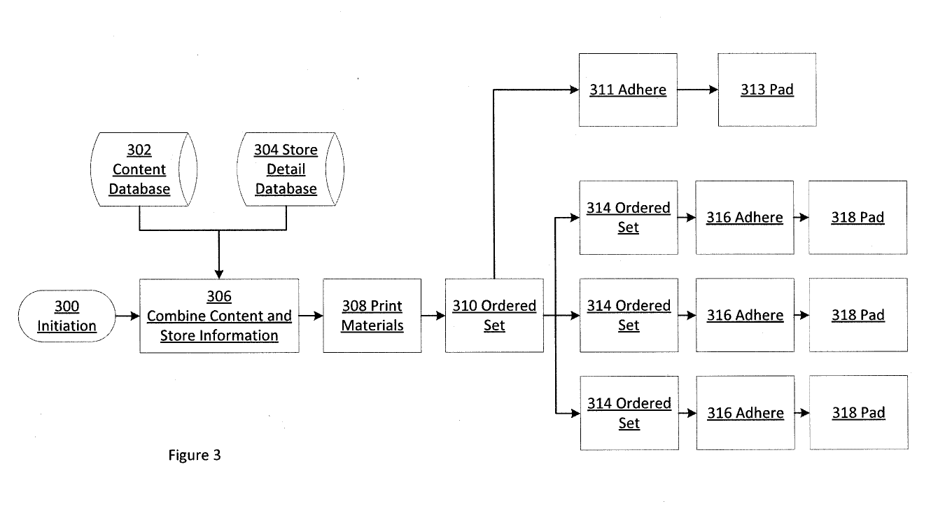

Referring now to FIG. 3, one method of preparing the display materials is depicted. A user of the system initiates the preparation of display materials at step 300. This may occur for a single store or retail environment, or multiple stores or retail environments. The step may be initiated for a number of reasons, such as changes to the content database 302 or to the store database 304. At step 306, the print processor 103 retrieves data from the two databases 302, 304 and combines the data to prepare an ordered list of display materials to be printed, as described above with reference to FIG. 1. The ordered list of display materials is then printed in step 308. In some embodiments, the resulting ordered set 310 may be adhered at step 311 into a single pad 313.

In other embodiments, the ordered set 310 may be divided into multiple ordered sets 314. This may be to provide for a more manageable pad size, or to split up the installation process into logical units, or other reasons. The ordered sets 314 may include a top sheet that provides an identifier for the ordered set 314. The ordered sets 314 may also include a bottom sheet that provides an indentifier for the next ordered set 314 to be installed in the sequence provided for the retail environment in store detail database 304. Each ordered set 314 may be adhered at a respective step 316 to create pads 318.

Many different arrangements and methods of using the invention are possible without departing from the spirit and scope of the present invention. Embodiments of the present invention are described herein with the intent to be illustrative rather than restrictive. Alternative embodiments will become apparent to those skilled in the art that do not depart from its scope. A skilled artisan may develop alternative means of implementing the disclosed improvements without departing from the scope of the present invention. Further, it will be understood that certain features and subcombinations are of utility and may be employed without reference to other features and subcombinations and are contemplated within the scope of the invention. The description should not be restricted to the specific described embodiments.

What is claimed is:

1. Display materials for a retail environment, comprising an ordered set of a plurality of individual display materials, wherein each of the individual display materials is releasably adhered to an adjacent individual display material in the ordered set whereby forming a pad, and wherein the ordered set is arranged in a predetermined sequence of installation for each of the individual display materials in the retail environment.

2. The display materials for a retail environment of claim 1, wherein the sequence of installation is the walk sequence for the retail environment.

3. The display materials for a retail environment of claim 1, wherein the ordered set is divided into a plurality of subsets of individual display materials wherein each subset forms a separate pad.

4. The display materials for a retail environment of claim 3, wherein an identifier for each pad is provided on a top sheet of the respective pad.

5. The display materials for a retail environment of claim 4, wherein an identifier for a next pad in the sequence of installation is provided on a bottom sheet attached to the bottom of a prior pad.

6. The display materials for a retail environment of claim 5, wherein a first of the individual display materials includes first product-identifying indicia and first price information, and wherein a second of the individual display materials includes second product-identifying indicia and second price information, the second product-identifying indicia being different from the first product-identifying indicia.

7. The display materials for a retail environment of claim 1, wherein a first of the individual display materials includes first product-identifying indicia and first price information, and wherein a second of the individual display materials includes second product-identifying indicia and second price information, the second product-identifying indicia being different from the first product-identifying indicia.

8. A pad of shelf labels for a retail environment, the pad comprising:
a plurality of sheets, each sheet comprising a single shelf label having a unique combination of product-identifying indicia and price information; and
releasable adhesive adhering each said sheet to an adjacent said sheet in a stacked configuration;
wherein the sheets are ordered in a predetermined sequence of installation in the retail environment.

9. The pad of claim 8, further comprising:
a top sheet providing an identifier for the pad; and
a bottom sheet providing an identifier for a next pad in the sequence of installation.

10. A method of manufacturing display materials for a retail environment, comprising the steps:
accessing a content database containing display information for individual display materials;
accessing a store detail database containing sequence information for the retail environment;
combining the display information with the sequence information to prepare an ordered set of individual display materials;
printing each of the individual display materials; and
applying reusable adhesive to adhere the individual display materials to each other in accordance with the sequence information to form a pad of ordered display materials, the reusable adhesive allowing the individual display materials to be coupled to store shelves after being separated from the pad.

11. The method of claim 10, wherein in the step of applying reusable adhesive, the reusable adhesive is applied to only a portion of each of the individual display materials.

12. The method of claim 11, wherein the reusable adhesive is a pressure-sensitive adhesive.

13. The method of claim 12, wherein the sequence information corresponds to a walk sequence of the retail environment, and wherein the pad of ordered display materials is stacked in accordance with the walk sequence.

14. The method of claim 10, wherein the step of applying reusable adhesive comprises the steps of:
separating the ordered set of individual display materials into a plurality of sets of individual display materials; and
adhering the individual display materials in each of the plurality of sets to form a plurality of pads of ordered display materials.

15. The method of claim 14, further comprising the step of adhering a top sheet containing sequence data to a top of each of the plurality of pads.

16. The method of claim 15, further comprising the step of adhering a bottom sheet containing sequence data to a bottom of each of the plurality of pads.
